(19) United States
(12) Patent Application Publication
(10) Pub. No.: US 2018/0336476 A1
(43) Pub. Date: Nov. 22, 2018

(54) INFORMATION PROCESSING SYSTEM, INFORMATION PROCESSING METHOD, AND INFORMATION PROCESSING PROGRAM

(71) Applicant: NEC Corporation, Tokyo (JP)

(72) Inventors: Ryohei FUJIMAKI, Tokyo (JP); Shinji ITO, Tokyo (JP)

(73) Assignee: NEC Corporation, Tokyo (JP)

(21) Appl. No.: 15/778,690

(22) PCT Filed: Aug. 29, 2016
(86) PCT No.: PCT/JP2016/003927

§ 371 Date: May 24, 2018

Related U.S. Application Data
(60) Provisional application No. 62/260,764, filed on Nov. 30, 2015.

(51) Int. Cl. G06N 5/02; G06N 99/00

(52) U.S. Cl. CPC G06N 5/025; G06N 99/005

(57) ABSTRACT

Provided is an information processing system which perform suitable optimization even if there are input data not observed in mathematical optimization. A learning unit 71 learns a predictive model on the basis of an explained variable and explanatory variables, the predictive model representing a relationship between explained variable and explanatory variables and being expressed by a function of the explanatory variables. A visualization unit 72 visualizes the predictive model. When receiving the operation from the user, an optimization unit 73 calculates an objective variable optimizing an objective function under constraints, the objective function using, as an argument, a predictive model visualized by the visualization unit 72.

### TECHNICAL FIELD

The present invention relates to an information processing system, an information processing method, and an information processing program which perform optimization on the basis of a learned predictive model.

### BACKGROUND ART

As a machine learning algorithm for generating a predictive model on the basis of past results, for example, regression analysis, neural network, support vector machine, or the like is known. Furthermore, PTL 1 describes a method of generating a predictive model on the basis of past results.

Furthermore, PTL 2 describes a system for representing a recommended price optimized to maximize potential profit on the basis of sales forecast and price sensitivity. In PTL 2, in this system, a price sensitivity model models the price sensitivity of a specific product by using a function varying in accordance with price, or models a change in sales as a function of a variation in price. Furthermore, the system described in PTL 2 predicts sales under predetermined assumption, uses results of the prediction and the price sensitivity to predict the sales of a product, and generates a set of optimum prices maximizing net profit under given constraints. Furthermore, the system displays the types of price sensitivity models and variable values of price sensitivity.

PTL 3 describes a system for evaluating the effectiveness of communication content and optimizing content distribution. The system described in PTL 3 uses reinforcement learning. In PTL 3, generation of a content distribution schedule predicted to maximize effectiveness evaluation scale (or objective function) is described. Furthermore, in PTL 3, a regression analysis is used for history data to predict the best “hybridization” of contents to maximize the past results is described.

### CITATION LIST

### Patent Literature

PTL 1: U.S. Pat. No. 8,909,582

PTL 2: Japanese Translation of PCT International Application Publication No. 2004-519021

PTL 3: Japanese Patent Application Laid-Open No. 2015-53071

### SUMMARY OF INVENTION

### Technical Problem

General mathematical optimization is premised on observation of input data to mathematical programming. For example, in optimization of production lines of industrial products, input data to mathematical programming includes amounts of materials, costs, producing times, and the like required for producing a product on each line. All of these input data is data observable by an analyst, when the analyst performs the mathematical programming.

Meanwhile, there is also a problem that is not solved without using data not observable by the analyst, when the analyst performs mathematical programming. For example, a store has a problem of optimization of the price of each item belonging to a merchandise group to maximize the total sales of the merchandise group. When mathematical programming is performed to solve this problem, for example, prediction values of the quantity of the item in the future is required as input data to the mathematical programming. However, when performing the mathematical programming by the analyst, the prediction value of the quantity of the item in the future is not data observable by the analyst. Accordingly, in the general mathematical optimization, such a problem has not been solved by using the mathematical solution.

Furthermore, for use of prediction to make decisions, a method for predicting effects for all possible strategies to select a strategy providing the best effect can be considered. However, this method disadvantageously increases the amount of calculation.

Therefore, an object of the present invention is to provide an information processing system, an information processing method, and an information processing program which perform suitable optimization even if there are input data not observed in mathematical optimization.

### Solution to Problem

An information processing system according to the present invention includes a learning unit, a visualization unit, and an optimization unit. The learning unit learns a predictive model on the basis of an explained variable and explanatory variables, in which the predictive model represents a relationship between the explained variable and the explanatory variables, and is expressed by a function of the explanatory variables. The visualization unit visualizes the predictive model. The optimization unit calculates an objective variable to optimize an objective function using the predictive model visualized by the visualization unit as an argument, under constraints, upon receiving user's operation.

Furthermore, an information processing method according to the present invention includes variable and explanatory variables, in which the predictive model represents a relationship between the explained variable and the explanatory variables, and is expressed by a function of the explanatory variables, visualizing the predictive model, and calculating an objective variable to optimize an objective function using the visualized predictive model as an argument, under constraints, upon receiving user's operation.

Furthermore, an information processing program according to the present invention causes a computer to execute a learning process, a visualization process, and an optimization process. The learning process is executed to learn a predictive model on the basis of an explained variable and explanatory variables, in which the predictive model represents a relationship between the explained variable and the explanatory variables, and is expressed by a function of the explanatory variables. The visualization process is executed to visualize the predictive model. The optimization process is executed to calculate an objective variable optimizing an objective function under constraints upon receiving user's operation, in which the objective function uses as an argument the predictive model visualized in the visualization process.

### Advantageous Effects of Invention

According to the present invention, even if there are input data not observed in mathematical optimization, optimization can be performed suitably.

### BRIEF DESCRIPTION OF DRAWINGS

FIG. 1 It depicts a block diagram illustrating an example of an information processing system according to the present invention.

FIG. 2 It depicts an explanatory diagram illustrating an example of a screen displayed on a display device by a display control unit.

FIG. 3 It depicts an explanatory diagram illustrating another display example of a predictive model in a predictive model display section.

FIG. 4 It depicts an explanatory diagram illustrating an example of a predictive model display section including a display section for a scatter diagram.

FIG. 5 It depicts a flowchart illustrating an example of a process of the present invention.

FIG. 6 It depicts a flowchart illustrating an example of a process of the present invention.

FIG. 7 It depicts a schematic block diagram illustrating an exemplary configuration of a computer according to an exemplary embodiment of the present invention.

FIG. 8 It depicts a block diagram illustrating an outline of an information processing system according to the present invention.

### DESCRIPTION OF EMBODIMENTS

Firstly, the outline of the present invention will be described. An information processing system according to the present invention learns from data in the past a predictive model for predicting unobserved data, and automatically generates an objective function of mathematical programming on the basis of the predictive model to perform optimization. Furthermore, the information processing system according to the present invention visualizes the learned predictive model (i.e., displays the learned predictive model on a display device), and performs optimization upon receiving user's operation giving an instruction to perform optimization.

Exemplary embodiments of the present invention will be described below with reference to the drawings. It should be noted that optimization of the prices of a plurality of items to maximize the total sales of the plurality of items on the basis of the prediction of the quantities of the plurality of items is exemplified in the following description. However, an object to be optimized is not limited to the above example. Furthermore, in the following description, a variable being an object to be predicted by using machine learning is referred to as “explained variable”. A variable used for prediction is referred to as an “explanatory variable”. A variable being an output from optimization is referred to as an “objective variable”. Note that these variables are not exclusive of each other, and, for example, some of the explanatory variables may be the objective variables.

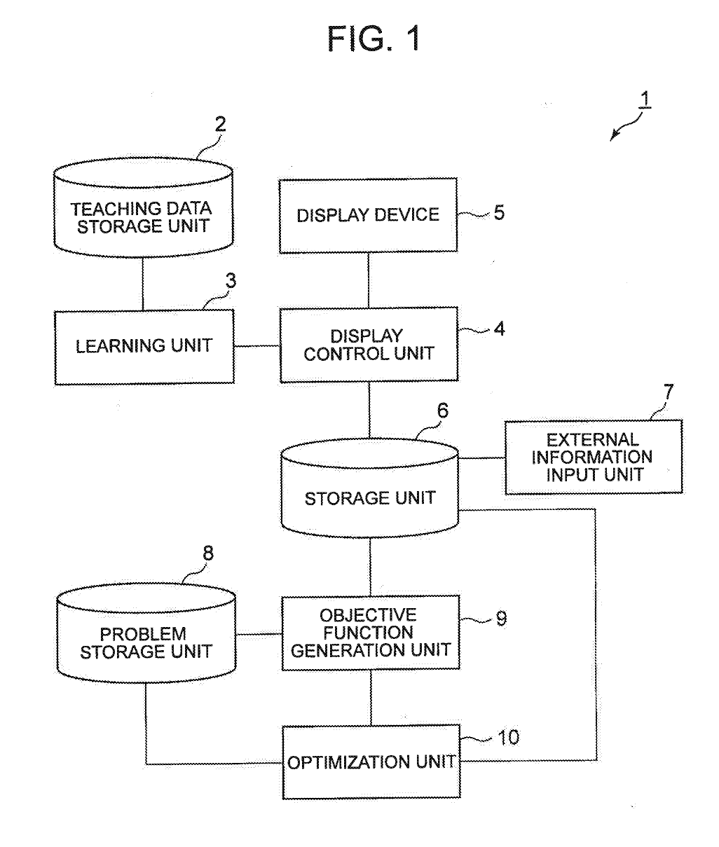

FIG. 1 is a block diagram illustrating an example of an information processing system according to the present invention. An information processing system 1 according to the present invention includes a teaching data storage unit 2, a learning unit 3, a display control unit 4, a display device 5, a storage unit 6, an external information input unit 7, a problem storage unit 8, an objective function generation unit 9, and an optimization unit 10.

The display control unit 4 visualizes a predictive model learned by the learning unit 3 (i.e., displays information about the predictive model on the display device 5). The display control unit 4 displays not only the information about the predictive model but also a user interface for a user to input a parameter used for learning, a user interface for the user to input constraints for optimization, an optimization result, and the like on the display device 5.

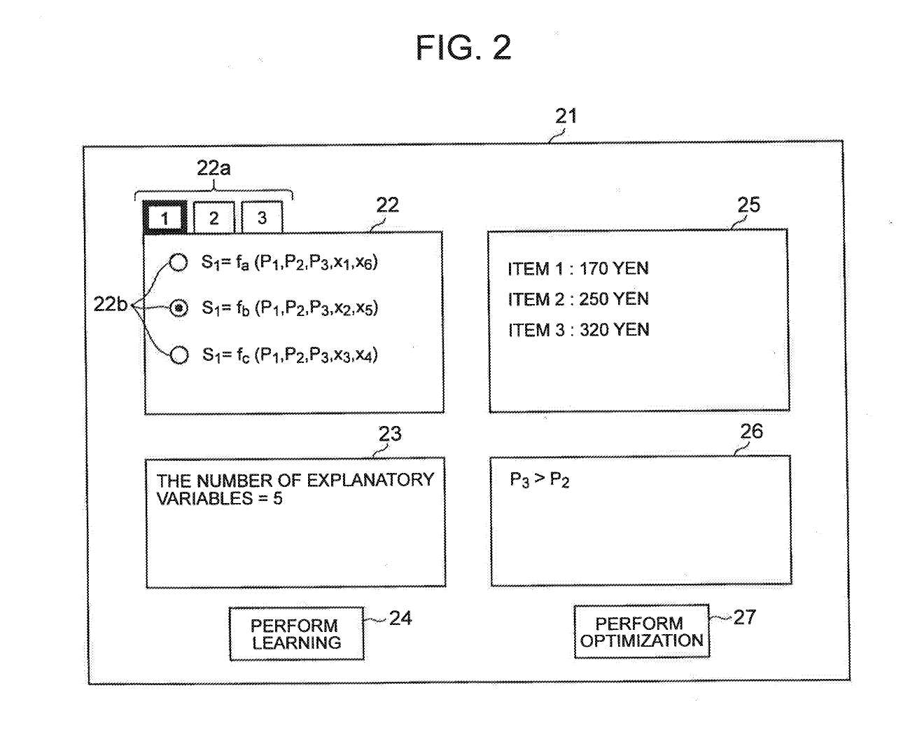

FIG. 2 is an explanatory diagram illustrating an example of a screen displayed on the display device 5 by the display control unit 4. The screen 21 displayed by the display control unit 4 includes a predictive model display section 22, an input section 23 for a parameter used for learning (hereinafter, referred to as a first input section 23), an optimization result display section 25, and an input section 26 for constraints for optimization (hereinafter, referred to as a second input section 26). Furthermore, the screen 21 includes a button 24 for the user to give an instruction to perform learning (hereinafter, referred to as a first instruction button 24), and a button 27 for the user to give an instruction to perform optimization (hereinafter, referred to as a second instruction button 27).

FIG. 2 illustrates an exemplary screen displayed by the display control unit 4, and the mode of the screen is not limited to the example illustrated in FIG. 2. For example, in FIG. 2, the learning and optimization performed by the instructions from the user through the button are exemplified, but the instructions may be given via a screen of another mode.

The predictive model display section 22 is a section in which information about the learned predictive model is displayed. The predictive model represents a relationship between the explained variable and the explanatory variables and is expressed by a function of the explanatory variable. Furthermore, in the present exemplary embodiment, the learning unit 3 uses a plurality of kinds of learning algorithms for each explained variable to learn a plurality of kinds of predictive models, as described later. Here, for ease of description, the explained variables have three kinds of “the quantity of item 1”, “the quantity of item 2”, “the quantity of item 3”. Furthermore, the learning unit 3 uses three kinds of learning algorithms (here, regression analysis, neural network, and support vector machine) to learn a predictive model for each learning algorithm. Accordingly, the learning unit 3 learns a predictive model according to the regression analysis, a predictive model according to the neural network, and a predictive model according to the support vector machine for the quantity of item 1 (defined as S₁). The learning unit 3 learns three kinds of predictive models similarly for the other explained variables. Note that, the predictive models which the learning unit 3 learns for each explained variable are not limited to three kinds.

The predictive model display section 22 includes tabs 22a for selecting an explained variable. The tabs correspond one by one to the explained variables. FIG. 2 illustrates an example in which a tab corresponding to the explained variable “the quantity of item 1” is selected by the user, and the display control unit 4 displays three kinds of predictive models learned for “the quantity of item 1” on the predictive model display section 22. Note that, in FIG. 2, fₐ is a predictive model according to the regression analysis, f_{b} is a predictive model according to the neural network, and f_{c} is a predictive model according to the support vector machine. In FIG. 2, a predictive model is schematically displayed, like S₁=fₐ(P₁, P₂, P₃, x₁, x₆), but the display control unit 4 displays a specific function, as the predictive model, in the predictive model display section 22. When another tab is selected by the user, the display control unit 4 displays information about three kinds of predictive models learned for the explained variable corresponding to the selected tab.

The predictive model display section 22 includes a user interface for the user to select one predictive model from the three kinds of predictive models, for each explained variable (i.e., for each tab). FIG. 2 illustrates an example in which the user interface is a radio button 22b. The user determines the most suitable one predictive model from the displayed three kinds of predictive models, for each explained variable, and operates the radio button 22b to select the predictive model. At this time, the user may select a predictive model independently for each explained variable. For example, the user may select a predictive model according to the neural network for “the quantity of item 1”, a predictive model according to the regression analysis for “the quantity of item 2”, and a predictive model according to the support vector machine for “the quantity of item 3”.

The first input section 23 is a section for the user to input a parameter used for learning. In the example illustrated in FIG. 2, the user inputs a numeral “5” as the number of explanatory variables used for the predictive models. The learning unit 3 uses this parameter to learn each predictive model so that the number of explanatory variables used for the predictive model is five. Note that, here, as an example of the parameter used for learning, the number of explanatory variables used for the predictive model is described, but the parameter used for learning is not limited to the present example. For example, “perform learning on the basis of teaching data of which period in the past” may be specified in the first input section 23.

The optimization result display section 25 is a section for displaying values of optimized objective variables. In the present example, it is assumed that “price of item 1”, “price of item 2”, and “price of item 3” are objective variables. The display control unit 4 displays optimized results of the objective variables on the optimization result display section 25.

The second input section 26 is a section for the user to input constraints for optimization. The constraints may have any content and, for example, restrictions in business are input as the constraints. For example, in the example illustrated in FIG. 2, P₃ is a variable corresponding to the “price of item 3” and P₂ is a variable corresponding to the “price of item 2”. Accordingly, “P₃>P₂” exemplified in the second input section 26 represents the constraints expressing that “price of item 3” is higher than “price of item 2”. The optimization unit 10 optimizes the values of the objective variables to satisfy the constraints. Note that the constraints are not limited to the above example. For example, when the quantity of item 1 is S₁, and the quota thereof is q, constraints “S₁≥q” may be input to the second input section 26. Furthermore, a parameter used for optimization may be input to the second input section 26.

The first instruction button 24 is a button for the user to give an instruction to perform learning. When the first instruction button 24 is clicked, the learning unit 3 learns the predictive models.

The second instruction button 27 is a button for the user to give an instruction to perform optimization. When the second instruction button 27 is clicked, the objective function generation unit 9 and the optimization unit 10 sequentially perform processing.

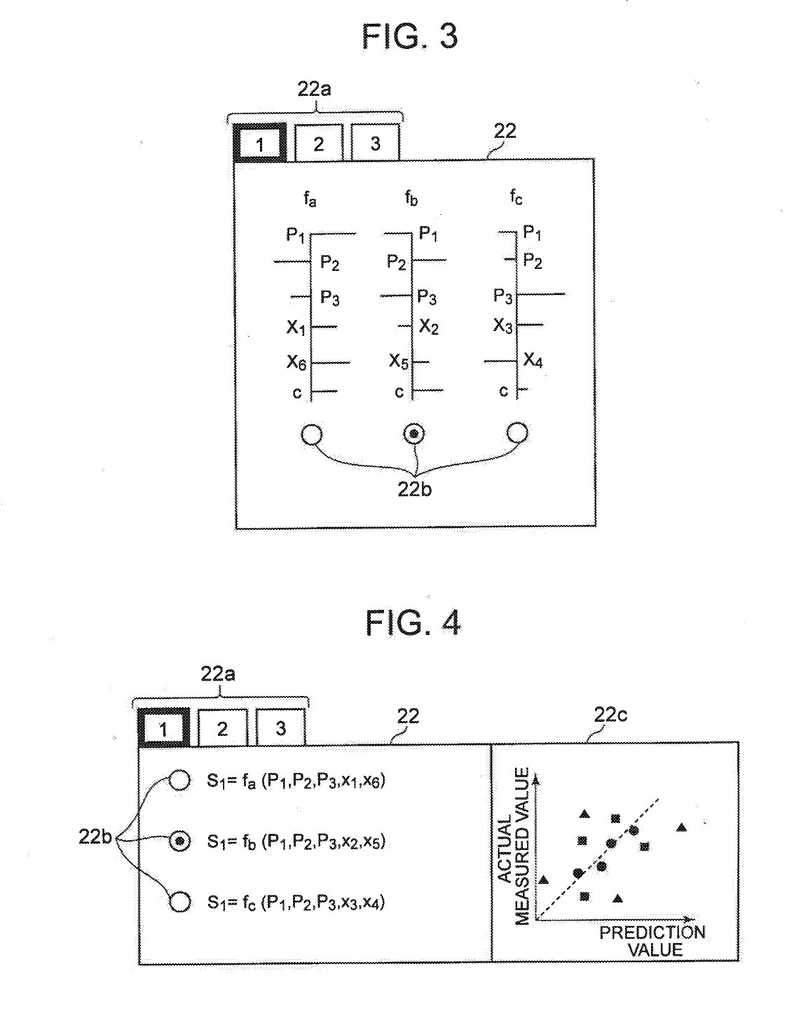

As described above, in the predictive model display section 22, the user determines the most suitable one predictive model from the displayed three kinds of predictive models, for each explained variable, and selects the predictive model. Preferably, the user can accurately determine the most suitable predictive model. Therefore, the display control unit 4 may display information about a predictive model as exemplified in FIG. 3, without directly displaying a specific function as the predictive model. Here, each predictive model is expressed by a formula in the form of Y=a₁×X₁+a₂×X₂+ . . . aₙ×Xₙ+c. In the formula, Y is an explained variable, X₁, X₂, . . . , and Xₙ are explanatory variables. In the formula, a₁, a₂, . . . , and aₙ are coefficients corresponding to the respective explanatory variables. In the formula, c is a constant term.

In the example illustrated in FIG. 3, P₁, P₂, P₃, and x₁ to x₆ are explanatory variables. In FIG. 3, a bar horizontally displayed expresses a coefficient corresponding to each of the explanatory variables. Specifically, the bar represents a positive coefficient or a negative coefficient depending on which side of a center line the bar is on, and the length of the bar represents an absolute value of the coefficient. When the bar is on the right side of the center line, the coefficient is positive, and when the bar is on the left side of the center line, the coefficient is negative. In fₐ illustrated in FIG. 3, it is found that the explanatory variable P₁ has a positive coefficient, and the absolute value of the coefficient of the explanatory variable P₁ is larger than the absolute values of the coefficients of any other explanatory variables in fₐ. Furthermore, in FIG. 3, a mark indicating the explanatory variable is illustrated in the vicinity of the bar, but which bar corresponds to which explanatory variable may be indicated in another mode. A display form exemplified in FIG. 3 allows the user to readily confirm whether an important explanatory variable is missing or whether the coefficient of the important explanatory variable has an inappropriate value, for accurate determination of the most suitable predictive model. The coefficient of the important explanatory variable having an inappropriate value represents that, for example, the coefficient which should be positive is negative, the coefficient which should be negative is positive, or the absolute value of the coefficient is considerably large or considerably small.

Furthermore, for ease of accurate determination of the most suitable predictive model by the user, the display control unit 4 may use test data including a value of an explained variable and a value of an explanatory variable in the past to calculate a value of an explained variable for each predictive model, visualizing a difference between the value of the explained variable and the value of the explained variable in the past. Furthermore, the display control unit 4 may use a scatter diagram to visualize the difference. FIG. 4 is an explanatory diagram illustrating an example of the predictive model display section 22 including a display section 22c for such a scatter diagram. In the display section 22c for a scatter diagram, the value of an explained variable calculated on the basis of the test data is referred to as a prediction value, and the value of an explained variable in the past is referred to as a result value. Furthermore, in the display section 22c for a scatter diagram, a triangular marker represents a relationship between a prediction value calculated using a predictive model firstly displayed and a result value. A circular marker represents a relationship between a prediction value calculated using a predictive model secondly displayed and a result value. A square marker represents a relationship between a prediction value calculated using a predictive model thirdly displayed and a result value. The closer the marker is to a broken line represented in the scatter diagram, the smaller a difference between the prediction value and the result value is. Accordingly, for example, when the scatter diagram exemplified in FIG. 4 is displayed, since the circular markers are closer to the broken line, the user can determine that the predictive model secondly displayed is the most suitable. Note that when the tab is switched to a selected tab, the display control unit 4 displays a new scatter diagram.

Furthermore, in a display mode illustrated in FIG. 3, the display control unit 4 may display the display section 22c for a scatter diagram exemplified in FIG. 4.

Furthermore, for ease of accurate determination of the most suitable predictive model by the user, the display control unit 4 may perform cross-validation.

The teaching data storage unit 2 stores various teaching data used by the learning unit 3 to learn the predictive models. In the present exemplary embodiment, the teaching data storage unit 2 stores past result data for a variable (objective variable) output as an optimization result from the optimization unit 10. For example, when the optimization unit 10 optimizes the prices of a plurality of items, the teaching data storage unit 2 stores, as the past result data, the price of each item corresponding to an explanatory variable or the quantity of each item corresponding to an explained variable. Furthermore, the teaching data storage unit 2 also stores external information (e.g., weather, calendar information, or the like) other than the above data. These external information can also be explanatory variables. The teaching data storage unit 2 is achieved, for example, by a magnetic disk device.

Note that the test data described above may only be stored, for example, in the teaching data storage unit 2, separately from the teaching data.

When receiving an operation giving an instruction to perform learning (in the present example, when the first instruction button 24 is clicked), the learning unit 3 learns the predictive models by using machine learning for each of set explained variables, on the basis of various teaching data stored in the teaching data storage unit 2. At this time, the learning unit 3 learns a plurality of kinds of predictive models by using a plurality of kinds of learning algorithms, for each explained variable. Furthermore, the learning unit 3 uses a parameter input to the first input section 23 to learn each of the predictive models. For example, as described above, when “5” is specified as the number of explanatory variables used for the predictive models, the learning unit 3 learns each predictive model so that the number of explanatory variables used for the predictive model is five.

Each of the predictive models learned in the present exemplary embodiment is expressed by a function including, as an explanatory variable, a variable (objective variable) output as an optimization result from the optimization unit 10. That is, the objective variable is an explanatory variable of the predictive model. For example, it is assumed that “price of item 1”, “price of item 2”, and “price of item 3” are objective variables P₁, P₂, and P₃, respectively. The learning unit 3 uses, for example, P₁, P₂, and P₃ as the explanatory variables in each predictive model. The learning unit 3 further automatically determines the other explanatory variables. At this time, the learning unit 3 may only determine the explanatory variables from among various articles (e.g., weather or the like) included in the external information stored in the teaching data storage unit 2. As described above, when the number of explanatory variables used for the predictive models is determined as the parameter, the learning unit 3 determines the explanatory variables used for the predictive models in accordance with the number of explanatory variables. The explanatory variables other than P₁, P₂, and P₃ may be different between the predictive models.

The plurality of kinds of learning algorithms is not particularly limited. For example, in the above example, the regression analysis, the neural network, and the support vector machine are exemplified, but the learning unit 3 may employ the method described in PTL 1, for a predictive model learning method. Furthermore, the number of kinds of learning algorithms is not limited.

Here, a set of indices of objects to be optimized is expressed as {m|m=1, . . . , M}. In the example of the present exemplary embodiment, the object to be optimized is the price of each item, and M corresponds to the number of items. Furthermore, the content of prediction of each object m to be optimized is referred to as Sₘ. In the example of the present exemplary embodiment, Sₘ corresponds to the quantity of item m. Furthermore, the content of optimization of each object m to be optimized (i.e., objective variable for optimization) is referred to as Pₘ or P′ₘ. In the example of the present exemplary embodiment, Pₘ corresponds to the price of item m. When a dependence relationship between Sₘ (e.g., quantity) and Pₘ (e.g., price) is modeled using a linear regression (one kind of regression analysis), a predictive model for predicting Sₘ is expressed, for example, by Formula 1, which is exemplified below.

$$\begin{matrix}[ Mathematical Formula 1 ] & \\ {S}_{m} = {α}_{m} + {\sum }_{{m}^{′} = 1}^{M} {\sum }_{d = 1}^{D} {β}_{{mm}^{′}}^{d} {f}_{d} ( {P}_{m}^{′} ) + {\sum }_{d = 1}^{{D}^{′}} {γ}_{d}^{m} {g}_{d} & ( Formula 1 )\end{matrix}$$

In Formula 1, f_{d} is a feature generation function and represents conversion of P′ₘ. Furthermore, D represents the number of feature generation functions and indicates the number of conversions performed on P′ₘ. The function f_{d} may have any content, and may be, for example, a function performing linear transformation or may be a function performing non-linear transformation, such as logarithm or polynomial. As described above, when Pₘ is the price of item m and Sₘ is the quantity of item m, f_{d} represents, for example, sales response to price. The sales response represents that, for example, a certain degree of reduction in price increases or reduces sales response or the quantity is squared with a reduction in price.

Furthermore, in Formula 1, g_{d} is an external feature (weather or the like in the above example), and D′ is the number of external features. Note that the external feature may be converted in advance. Furthermore, α, β, and γ in Formula 1 are each a constant term or a coefficient of a regression formula obtained as a result of the machine learning by the learning unit 3. As apparent from the above description, each predictive model is learned on the basis of an explained variable (Sₘ) and explanatory variables (Pₘ, various external features, and the like), and the predictive model represents a relationship between the explained variable and the explanatory variables, and is expressed by a function of the explanatory variables.

The storage unit 6 stores each predictive model selected by the user for each explained variable, constraints for optimization input to the second input section 26, and a parameter used for optimization. When receiving an operation giving an instruction to perform optimization (in the present example, when the second instruction button 27 is clicked), the display control unit 4 causes the storage unit 6 to store each predictive model selected by the user for each explained variable, and constraints or a parameter (parameter used for optimization) input to the second input section 26. Furthermore, the storage unit 6 also stores the external information input by the external information input unit 7. The storage unit 6 is achieved, for example, by a magnetic disk device.

The external information input unit 7 inputs external information used for optimization, excluding predictive models selected by the user for the respective explained variables and the constraints and parameter for the optimization. For example, in the above example, when a price of an item on a certain day is optimized, the external information input unit 7 may input information about weather (predicted weather) on the day. Furthermore, for example, when store traffic on the day can be predicted, the external information input unit 7 may input information about store traffic on the day. As described in the example of store traffic, the external information may be generated by the predictive models using machine learning. The information input here is applied to, for example, an explanatory variable for the predictive models.

Information input by the external information input unit 7 may only be prepared in advance, for example, by the user.

The problem storage unit 8 stores a mathematical programming problem which is solved by optimization. The mathematical programming problem is previously stored in the problem storage unit 8 by the user or the like. Note that the display control unit 4 may be configured to cause the problem storage unit 8 to store the mathematical programming problem when the mathematical programming problem is input into the second input section 26 and the second instruction button 27 is clicked. Here, a description is made of an example in which the problem storage unit 8 previously stores the mathematical programming problem. The problem storage unit 8 is achieved, for example, by a magnetic disk device.

Note that in the present exemplary embodiment, the “form” of the objective function described in the mathematical programming problem is defined so that a predictive model serves as a parameter. In the example of the present exemplary embodiment, the problem storage unit 8 stores a mathematical programming problem for maximizing the total sales of the plurality of items. In this configuration, the optimization unit 10 optimizes the price of each item to maximize the total sales of the plurality of items. The sales of each item can be defined by the product of the price of the item and the quantity of the item predicted by a predictive model. Accordingly, the “form” of the objective function representing the total sales of each item is represented as the following Formula 2.

$$\begin{matrix}[ Mathematical Formula 2 ] & \\ {\sum }_{m = 1}^{M} {P}_{m} {S}_{m} & ( Formula 2 )\end{matrix}$$

Formula 2 is a formula representing a total of the products of the price of an item and the quantity of the item predicted by a predictive model, but a predictive model representing the quantity Sₘ is not substituted. Therefore, Formula 2 is referred to as the “form” of the objective function.

In the present example, the problem storage unit 8 may only be caused to previously store a mathematical programming problem expressed in the following Formula 3.

$$\begin{matrix}[ Mathematical Formula 3 ] & \\ {max}_{z} {\sum }_{m = 1}^{M} {P}_{m} {S}_{m} & ( Formula 3 )\end{matrix}$$

Formula 3 represents a mathematical programming problem for maximizing the total sales of each item. The “form” of the objective function expressed in Formula 2 is described in Formula 3.

The objective function generation unit 9 generates an objective function of the mathematical programming problem. Specifically, the objective function generation unit 9 generates an objective function of the mathematical programming problem using a predictive model as the parameter. The objective function generation unit 9 substitutes a predictive model selected by the user for each explained variable into the “form” of the objective function described in the mathematical programming problem stored in the problem storage unit 8 (Formula 2 in the above example) to generate an objective function. Here, for ease of description, the value of M in Formula 2 is 3 (i.e., the number of items is three). In this case, the user selects a specific predictive model (function) representing an explained variable for each explained variable of “quantity S₁ of item 1”, “quantity S₂ of item 2”, or “quantity S₃ of item 3”. Predictive models (functions) corresponding to S₁, S₂, and S₃ are stored in the storage unit 6. The objective function generation unit 9 substitutes the respective predictive models into the “form” of the objective function expressed in Formula 2 to generate objective variables.

The optimization unit 10 optimizes an objective content on the basis of various information stored in the storage unit 6 (constraints and a parameter for optimization input via the second input section 26, and external information input by the external information input unit 7). At this time, the optimization unit 10 optimizes the value of an objective variable so that an objective function has an optimum value. Since the constraints are determined for the objective variables or the like, the optimization unit 10 optimizes the values of the objective variables so that the objective functions have an optimum value (e.g., maximum, minimum, or the like) while satisfying constraints.

In the present example, since the mathematical programming problem stored in the problem storage unit 8 is defined as expressed in Formula 3, the optimization unit 10 optimizes the value of an objective variable so that an objective function has a maximum value while satisfying constraints. The optimization unit 10 solves the mathematical programming problem specified by Formula 3 to optimize the prices P₁, P₂, . . . , and P_{M} of the respective items corresponding to the objective variables. That is, the optimization unit 10 derives the price of each item to maximize the total sales of each item.

The optimization unit 10 optimizes the value of each objective variable, and causes the storage unit 6 to store the value of each objective variable. Then, the display control unit 4 displays optimum values of the respective objective variables, in the optimization result display section 25 in the screen 21 displayed on the display device 5.

The learning unit 3, the display control unit 4, the external information input unit 7, the objective function generation unit 9, and the optimization unit 10 are each achieved by, for example, a CPU of a computer operated in accordance with a program (information processing program). In this case, for example, the CPU may only read the program from a program recording medium such as a program storage device of the computer (not illustrated in FIG. 1) to be operated as the learning unit 3, the display control unit 4, the external information input unit 7, the objective function generation unit 9, and the optimization unit 10, in accordance with the program.

Furthermore, each of the learning unit 3, the display control unit 4, the external information input unit 7, the objective function generation unit 9, and the optimization unit 10 may be achieved by dedicated hardware. Each of the learning unit 3, the display control unit 4, the external information input unit 7, the objective function generation unit 9, and the optimization unit 10 may be achieved by an electric circuit configuration (circuitry). Here, the electric circuit configuration (circuitry) is wording conceptually including a single device, multiple devices, chipset, or cloud.

Furthermore, the information processing system 1 according to the present invention may have a configuration in which two or more physically separated devices are connected to each other in a wired or wireless manner.

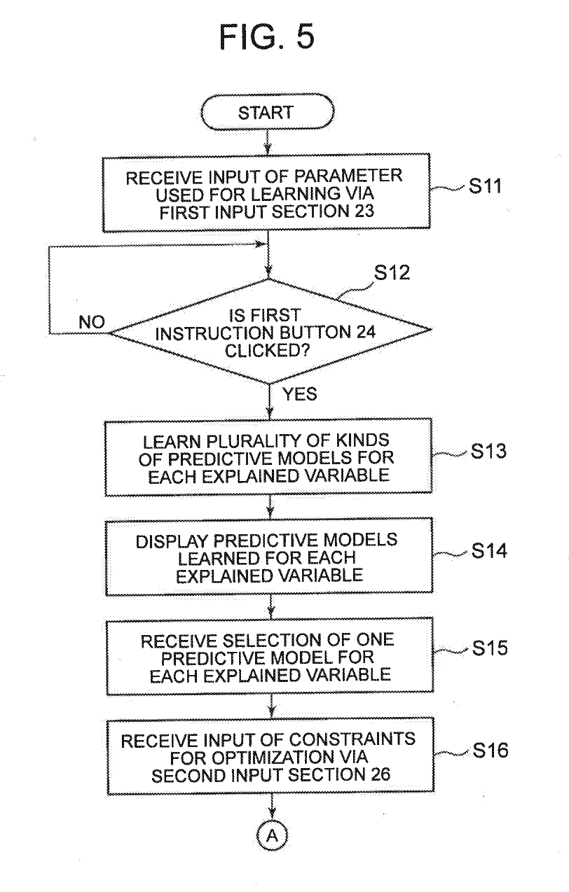

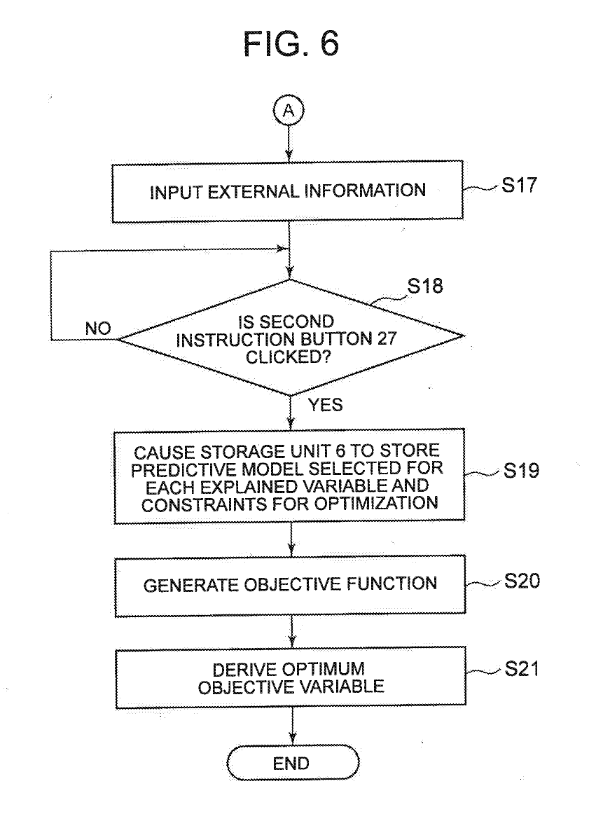

Next, a process of the present invention will be described. FIGS. 5 and 6 are flowcharts illustrating an exemplary process of the present invention.

Firstly, the display control unit 4 displays the screen 21 on the display device 5. However, in an initial state, no predictive model or no optimization result is displayed on the predictive model display section 22 and the optimization result display section 25. Furthermore, the first input section 23 and the second input section 26 are in blank.

The user inputs the parameter used for learning to the first input section 23. According to the user's operation, the display control unit 4 receives the input of the parameter used for learning via the first input section 23 (step S11). The display control unit 4 displays the input parameter in the first input section 23.

When the user does not click the first instruction button 24 (No in step S12), the information processing system 1 waits until the user clicks the first instruction button 24. During that time, the parameter input to the first input section 23 may be changed by the user.

When the user clicks the first instruction button 24 (Yes in step S12), the learning unit 3 learns the predictive models on the basis of the parameter input to the first input section 23 and various teaching data stored in the teaching data storage unit 2 for each preset explained variable (step S13). At this time, the learning unit 3 learns a plurality of kinds of predictive models by using a plurality of kinds of learning algorithms, for each explained variable.

Next, the display control unit 4 displays information about predictive models learned for each explained variable (step S14). Since a plurality of kinds of predictive models is learned for each explained variable, the display control unit 4 displays a plurality of predictive models for each explained variable.

In step S14, for example, as exemplified in FIG. 2, the display control unit 4 may only display information about the predictive models in the predictive model display section 22 including the tabs 22a and the radio buttons 22b. The tabs correspond one by one to the explained variables. For example, when one tab is selected by the user, the display control unit 4 displays a plurality of predictive models learned for an explained variable corresponding to the tab in the predictive model display section 22. When the tab is switched to a selected tab, the display control unit 4 may only display a plurality of predictive models learned for an explained variable corresponding to the new selected tab in the predictive model display section 22.

Note that the display control unit 4 may display information about the predictive models in a mode exemplified in FIG. 3. Furthermore, the display control unit 4 may display the scatter diagram with the predictive models (see FIG. 4).

The user determines the most suitable predictive model from the plurality of predictive models being displayed for each explained variable (i.e., for each tab), and operates the radio button 22b to select the predictive model. According to the user's operation, the display control unit 4 receives the selection of one predictive model for each explained variable (step S15). Note that, in the present exemplary embodiment, the user interface for the user to select one predictive model from the predictive models is exemplified as the radio buttons, but the form of the user interface may not be the radio buttons.

Then, the user inputs constraints for optimization to the second input section 26. According to the user's operation, the display control unit 4 receives the input of the constraints for optimization via the second input section 26 (step S16). The display control unit 4 displays the input constraints in the second input section 26. Furthermore, in step S16, the user may also input the parameter used for optimization to the second input section 26. In this configuration, the display control unit 4 may only similarly receive the input of the parameter and display the parameter in the second input section 26.

Furthermore, the external information input unit 7 inputs external information and causes the storage unit 6 to store the external information (step S17).

After step S17, when the user does not click the second instruction button 27 (No in step S18), the information processing system 1 waits until the user clicks the second instruction button 27. During that time, another input predictive model may be selected by the user, or the constraints or the like input to the second input section 26 may be changed by the user.

When the user clicks the second instruction button 27 (Yes in step S18), the display control unit 4 causes the storage unit 6 to store a predictive model selected for each explained variable and the constraints input to the second input section 26 (step S19). When the parameter used for optimization has been also input, the display control unit 4 causes the storage unit 6 to store the parameter as well.

Next, the objective function generation unit 9 reads a predictive model selected for each explained variable from the storage unit 6, and reads a mathematical programming problem stored in the problem storage unit 8. The mathematical programming problem is expressed, for example, as exemplified in Formula 3, and in the mathematical programming problem, the “form” of the objective function as exemplified in Formula 2 is described. The objective function generation unit 9 substitutes a specific predictive model selected for each explained variable into the “form” of the objective function as exemplified in Formula 2 to generate an objective function (step S20).

The optimization unit 10 reads the constraints or the external information from the storage unit 6, solves the mathematical programming problem satisfying the constraints, and derives an optimum value of each objective variable (step S21). For example, as expressed in Formula 3, when a mathematical programming problem for maximizing the total sales of each item is determined, the optimization unit 10 derives the values of objective variables P₁, P₂, . . . , P_{M} to maximize the objective function generated in step S20, under the constraints.

The optimization unit 10 causes the storage unit 6 to store the derived optimum value of each objective variable. The display control unit 4 reads the optimum value of each objective variable from the storage unit 6 and displays the optimum value in the optimization result display section 25. Thus, the user can understand the optimum value of each objective variable (e.g., the price of each item maximizing the total sales of each item).

In the above process, when the user determines that there is no suitable predictive model in the predictive models displayed in step S14, the user may change the parameter used for learning and input a new parameter to the first input section 23. In this case, the information processing system 1 may only perform the process again from step S11. That is, the information processing system 1 can repeat learning of the predictive models until the user determines that suitable predictive models can be obtained for each explained variable.

Furthermore, also when the user determines that the optimum values of the respective objective variables displayed in step S21 have no suitable value, the user may change the parameter used for learning and input a new parameter to the first input section 23. In this case, the information processing system 1 may only perform the process again from step S11. Alternatively, the user may perform operation of selecting one predictive model for each explained variable again, in the predictive model display section 22. In this case, the information processing system 1 may only perform the process again from step S15. Alternatively, the user may change the constraints for optimization and input new constraints to the second input section 26. In this case, the information processing system 1 may only perform the process again from step S16. That is, the information processing system 1 can repeat learning or optimization until the user determines that a suitable value is obtained as the optimum value of each objective variable.

According to the present invention, the objective function generation unit 9 substitutes a predictive model into a predetermined “form” of the objective function to generate an objective function. Then, the optimization unit 10 optimizes the value of the objective variable so that the objective function has an optimum value. That is, the optimization unit 10 optimizes the value of the objective variable so that the objective function using the predictive model as an argument has an optimum value. Accordingly, according to the present invention, even if there are input data not observed in mathematical optimization, optimization can be performed suitably.

Furthermore, according to the present invention, the display control unit 4 displays a predictive model learned for each explained variable in the predictive model display section 22. Accordingly, the user is allowed to confirm whether the learned predictive model is suitable. Accordingly, the user is allowed to confirm whether, for example, an empirically known phenomenon is reflected in the predictive model. Furthermore, the user is allowed to consider why an obtained optimum solution is suitable, after optimization.

Furthermore, in the present exemplary embodiment, the learning unit 3 learns a plurality of kinds of predictive models for each explained variable, and the display control unit 4 displays the plurality of kinds of predictive models for each explained variable in the predictive model display section 22. Accordingly, the user can select a predictive model determined to be most suitable, from a plurality of predictive models for each explained variable. Thus, the objective variable can have an optimum value with higher accuracy. Furthermore, for example, even if all predictive models are determined to be unsuitable in any of the explained variables, the parameter can be changed as described above to cause the learning unit 3 to learn the predictive models again.

Furthermore, also when the user determines that any of the objective variables has an unsuitable optimum value, the user can change the parameter used for learning, perform operation of selecting one predictive model again for each explained variable, or change the constraints for optimization, as described above, causing the information processing system 1 to perform optimization again.

Next, modifications of the present exemplary embodiment will be described.

In the above exemplary embodiment, the learning unit 3 uses a plurality of kinds of learning algorithms for each explained variable to learn a plurality of kinds of predictive models. The learning algorithm may be limited to one, and the learning unit 3 may learn one predictive model for each explained variable. In this case, the display control unit 4 may only display information about one predictive model for each explained variable (for each tab), in the predictive model display section 22. Furthermore, in this case, the display control unit 4 may not display the radio buttons 22b in the predictive model display section 22, and may also not perform the process of step S15. Furthermore, when the first instruction button 24 is clicked, the display control unit 4 may only cause the storage unit 6 to store the predictive model created for each explained variable.

Furthermore, the learning unit 3 may use the same learning algorithm to learn a plurality of predictive models. For example, the learning unit 3 may use teaching data for November 2015 to learn a predictive model using a certain learning algorithm, and use teaching data for December 2015 to learn another predictive model using the same learning algorithm. Furthermore, for example, the learning unit 3 may use the same learning algorithm and the same teaching data to learn a predictive model giving priority to the reduction of residuals in learning sections, and learn another predictive model putting emphasis on generalization function.

Furthermore, the display control unit 4 may receive user's editing operation to a displayed predictive model in the predictive model display section 22. In this configuration, the user can edit a predictive model displayed in the predictive model display section 22. Accordingly, the user can adjust a coefficient of an explanatory variable or a constant term of the displayed predictive model without changing the parameter nor causing the learning unit 3 to perform learning again. When the predictive model which has been edited is selected and the first instruction button 24 is clicked, the display control unit 4 may only cause the storage unit 6 to store the edited predictive model.

Furthermore, in the above exemplary embodiment, the example of learning or optimization performed by receiving an instruction from the user via a button. The user interface for giving an instruction to perform learning or optimization may have a form other than the first instruction button 24 and the second instruction button 27. For example, the display control unit 4 may display a command line user interface with the screen 21. In this configuration, the information processing system 1 may only perform the process of step S13 and the subsequent steps when a predetermined character string giving an instruction to perform learning is input to the command line user interface, and may only perform the process of step S19 and the subsequent steps when a predetermined character string giving an instruction to perform optimization is input to the command line user interface.

Note that, in FIG. 2, three objective variables (“price of item 1”, “price of item 2”, and “price of item 3”) are exemplified, but the number of objective variables, the values of which is to be optimized, is not particularly limited. Furthermore, the object to be predicted is not limited to the merchandise, and may be, for example, service or the like.

As an application example of the present invention where optimization of the prices of a plurality of items to maximize the total sales of the plurality of items on the basis of the prediction of the quantities of the plurality of items, the items being sandwiches will be described. Here, the kinds of items (sandwiches) are distinguished by symbols A, B, C, and D.

For example, maximization of the total sales of a sandwich group in a store on a certain day in the future will be described. The sandwich group includes four kinds of sandwiches A, B, C, and D. In this case, the information processing system 1 according to the present invention solves a problem that the prices of sandwiches A, B, C, and D are optimized to maximize the total sales of the sandwich group, that is, the total sales of the four kinds of sandwiches A, B, C, and D.

The teaching data storage unit 2 stores the quantity of each sandwich in the past and the price of each sandwich in the past. The teaching data storage unit 2 also stores, for example, external information, such as weather in the past or calendar information.

The learning unit 3 learns a plurality of kinds of predictive models (in the present example, predictive models for quantity) for each kind of sandwich by using a plurality of kinds of learning algorithms, on the basis of various teaching data stored in the teaching data storage unit 2.

Here, as an example of a predictive model for the quantity of sandwich A, a predictive model for quantity including an explanatory variable representing the price of each sandwich will be described. The quantity of each sandwich is considered to be affected by the price of sandwich A. Furthermore, the quantity of the sandwich A is considered to be also affected by the prices of sandwiches displayed on a shelf together with the sandwich A, that is, the prices of sandwiches B, C, and D. Customers visiting the store are considered to selectively buy desired sandwiches from the sandwiches A, B, C, and D displayed all together on the shelf.

It is assumed that, in this situation, for example, sandwich B is sold at a bargain price on a certain day. Even a customer who usually buys sandwich A may selectively buy sandwich B, not the sandwich A, on the day. This is because there is a limitation to the amount of sandwich a customer (human) can have at a time, and the customer is unlikely to buy both sandwiches A and B.

In this case, as a result, the bargain price of sandwich B causes a reduction in quantity of sandwich A. Such a relationship is called cannibalization (market cannibalization).

That is, cannibalization represents a relationship between a certain product and other competing products in which a reduction of the price of the certain product increases the quantity of the certain product but reduces the quantities of the competing products (a plurality of products having similar properties or features).

Accordingly, when the learning unit 3 learns a plurality of kinds of predictive models for the quantity of sandwich A, the learning unit 3 learns all of the predictive models as a function including, for the explanatory variables, a price P_{A} of sandwich A, a price P_{B} of sandwich B, a price P_{C} of sandwich C, and a price P_{D} of sandwich D. However, for the other explanatory variables, the learning unit 3 automatically selects some of various items (e.g., weather or the like) included in the external information appropriately, for each predictive model.

Learning of a plurality of kinds of predictive models for the quantity of sandwich B, learning of a plurality of kinds of predictive models for the quantity of sandwich C, and learning of a plurality of kinds of predictive models for the quantity of sandwich D are similarly performed.

As apparent from the above description, each predictive model is learned on the basis of an explained variable (in the present example, the quantity of sandwich) and explanatory variables (in the present example, the price of objective sandwich and the price of competing sandwich, and the like), and the predictive model represents a relationship between the explained variable and the explanatory variables, and is expressed by a function of the explanatory variables.

The information processing system 1 receives the selection of one predictive model from the user via the screen exemplified in FIG. 2, for each of sandwiches A, B, C, and D. Furthermore, in the information processing system 1, the input of the constraints for optimization is received via the screen exemplified in FIG. 2, and then the second instruction button 27 is clicked. Then, the objective function generation unit 9 substitutes the predictive model selected for each of the kinds of sandwiches into the “form” of the objective function (in the present example, Formula 2) described in the mathematical programming problem (in the present example, Formula 3) to generate an objective function of the optimization problem.

Thus, the optimization unit 10 calculates the values (i.e., the values of P_{A}, P_{B}, P_{C} and P_{D}) of the objective variables optimizing the corresponding objective functions under the constraints, on the basis of thus generated objective functions using the predictive models as arguments.

The optimization of the prices of a plurality of items to maximize the total sales of the plurality of items has been described above, but the present invention can also be applied to optimization of the prices of a plurality of items to maximize the total quantities of the plurality of items or maximize the profit. For example, when the price of each item is optimized to maximize the profit, a mathematical programming problem having a description of the “form” of an objective function representing the profit and representing maximization of the profit may only be stored in the problem storage unit 8.

Furthermore, as other application examples of the present invention, a first application example to a fifth application example will be described below.

As the first application example, optimization of the arrangement of items on shelves is described. In this case, the learning unit 3 generates a plurality of kinds of predictive models of the quantity Sₘ of an objective item m, for each item. At this time, the learning unit 3 generates a plurality of kinds of predictive models including explanatory variables representing the positions of the individual items on a shelf. For the other explanatory variables, the learning unit 3 appropriately performs automatic selection.

A mathematical programming problem in the present example is expressed, for example, by Formula 3.

When selection of one predictive model for each item and further input of constraints for optimization from the user are received, and the clicking of the second instruction button 27 by the user is received, the objective function generation unit 9 generates an objective function, and the optimization unit 10 determines the value (positions of the respective items on the shelf) of an objective variable maximizing the objective function.

As the second application example, optimization of hotel room rates will be described. Since this application example is provided to maximize sales or profit, an objective function is expressed by a function calculating the sales or profit. For example, a hotel room rate plan can be taken as objective variables. Compared with the above retail sales, “sandwich” in the example of the retail sales corresponds to, for example, “single room plan including breakfast” in the present application. Furthermore, for example, weather, season, or an event held around a hotel can be taken as the external information.

As the third application example, optimization between hotel room rates and the stock is described. Since this application example is also provided to maximize sales or profit, an objective function is expressed by a function calculating the sales or profit. For an objective variable, a content taking into consideration of the price and the stock is selected. For example, a variable representing for how much and when the hotel sells the rooms used for each room plan can be taken as a first objective variable, and a variable representing when and how many rooms the hotel sells for each room plan can be taken as a second objective variable. Furthermore, as in the second application example, weather, season, or an event to be held around a hotel can be taken as the external information.

As the fourth application example, optimization between the price and the stock of flight tickets is described. Since this application example is also provided to maximize sales or profit, an objective function is expressed by a function calculating the sales or profit. For an objective variable, as in the third application example, a content taking into consideration of the price and the stock is selected. Each flight ticket represents a route to a destination and the type (class) of a seat. In this case, for example, a variable representing for how much and when each flight ticket should be sold can be taken as a first objective variable, and a variable representing when and how much each flight ticket should be sold can be taken as a second objective variable. Furthermore, for example, season or an event to be held can be taken as the external information.

As the fifth application example, optimization of parking fees for parking lots is described. Since this application example is also provided to maximize sales or profit, an objective function is expressed by a function calculating the sales or profit. For example, parking fees according to time and location can be taken as objective variables. Furthermore, for example, parking fee for a neighboring parking lot or location information (distance or the like from a residential district, a business district, or a station) can be taken as the external information.

Note that service according to the present invention can be provided in the form of Software as a Service (Saas).

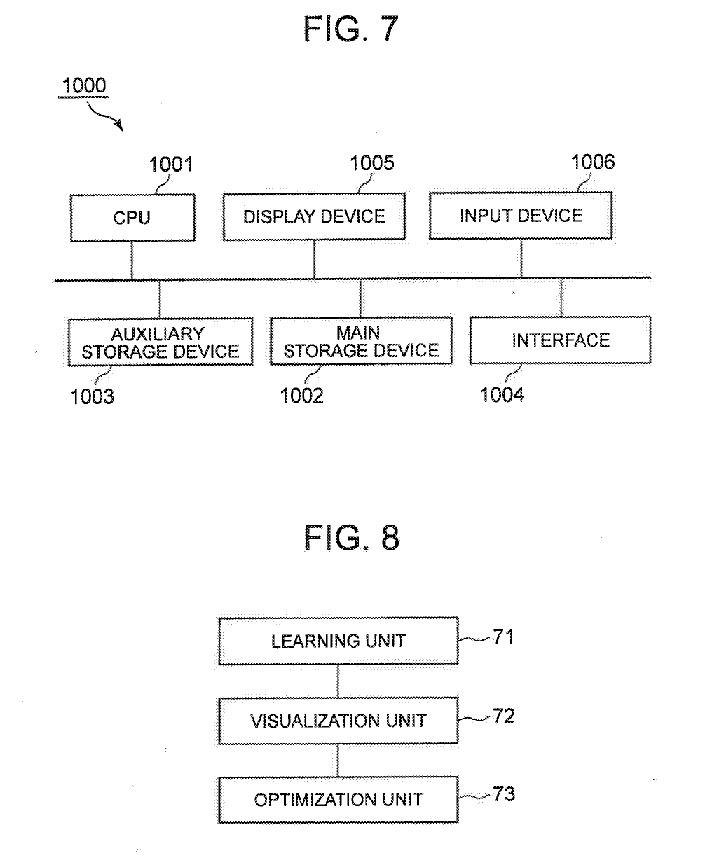

FIG. 7 is a schematic block diagram illustrating an exemplary configuration of a computer according to an exemplary embodiment of the present invention. The computer 1000 includes a CPU 1001, a main storage device 1002, an auxiliary storage device 1003, an interface 1004, a display device 1005, and an input device 1006.

The information processing system according to the present invention is mounted to the computer 1000. Operation of the information processing system according to the present invention is stored in the auxiliary storage device 1003 in the form of a program (information processing program). The CPU 1001 reads the program from the auxiliary storage device 1003, loads the program into the main storage device 1002, and performs the processing described above according to the program.

The auxiliary storage device 1003 is an example of a non-transitory tangible medium. Another example of the non-transitory tangible medium includes a magnetic disk, a magnetooptical disk, a CD-ROM, a DVD-ROM, a semiconductor memory or the like connected via the interface 1004. Furthermore, when this program is delivered to the computer 1000 through a communication line, the computer 1000 receiving the distributed program may load the program into the main storage device 1002 to perform the processing described above.

Furthermore, the program may partially achieve the process described above. Furthermore, the program may be a difference program combined with another program already stored in the auxiliary storage device 1003 to achieve the process described above.

Next, the outline of the present invention will be described. FIG. 8 is a block diagram illustrating an outline of an information processing system according to the present invention. The information processing system according to the present invention includes a learning unit 71, a visualization unit 72, and an optimization unit 73.

The learning unit 71 (e.g., the learning unit 3) learns a predictive model on the basis of an explained variable and explanatory variables, the predictive model representing a relationship between the explained variable and the explanatory variables and being expressed by a function of the explanatory variables.

The visualization unit 72 (e.g., the display control unit 4) visualizes the predictive model.

When receiving the operation from the user, the optimization unit 73 (e.g., the optimization unit 10) calculates an objective variable optimizing an objective function under constraints, in which the objective function uses, as an argument, a predictive model visualized by the visualization unit 72.

Owing to such a configuration, even if there are input data not observed in mathematical optimization, optimization can be performed suitably.

Furthermore, the learning unit 71 may use a plurality of kinds of learning algorithms to learn a plurality of kinds of predictive models, for each explained variable, the visualization unit 72 may visualize the plurality of kinds of predictive models to receive the selection of a predictive model from the user for each explained variable, and the optimization unit 73 may calculate an objective variable optimizing an objective function under constraints, in which the objective function uses a predictive model selected by the user for each explained variable as an argument.

Furthermore, the visualization unit 72 may use test data including a value of an explained variable and a value of an explanatory variable in the past to calculate the value of an explained variable for each predictive model, and visualizes a difference between the value of the explained variable and the value of the explained variable in the past.

Furthermore, the visualization unit 72 may receive user's editing operation to a visualized predictive model.

Furthermore, the learning unit 71 may learn a predictive model when receiving user's operation giving an instruction to perform learning of a predictive model.

It should be understood that although the present invention has been described above with reference to the exemplary embodiments, the present invention is not limited to the exemplary embodiments described above. Various changes and modifications which can be understood by a person skilled in the art may be made to the configurations and details of the present invention within the scope of the present invention.

The present application is based on and claims the benefit of priority from U.S. Provisional Application No. 62/260,764 filed on Nov. 30, 2015, the disclosure of which is incorporated herein in its entirety by reference.

### INDUSTRIAL APPLICABILITY

The present invention is preferably applied to an information processing system which performs optimization on the basis of a learned predictive model.

### REFERENCE SIGNS LIST

1 Information processing system
2 Teaching data storage unit
3 Learning unit
4 Display control unit
5 Display device
6 Storage unit
7 External information input unit
8 Problem storage unit
9 Objective function generation unit
10 Optimization unit

1. An information processing system comprising:
a learning unit implemented by a processor and that learns a predictive model on the basis of an explained variable and explanatory variables, the predictive model representing a relationship between the explained variable and the explanatory variables and being expressed by a function of the explanatory variables;
a visualization unit implemented by the processor and that visualizes the predictive model; and
an optimization unit implemented by the processor and that calculates an objective variable to optimize an objective function using the predictive model visualized by the visualization unit as an argument, under constraints, upon receiving user's operation.

2. The information processing system according to claim 1, wherein
the learning unit uses a plurality of kinds of learning algorithms to learn a plurality of kinds of predictive models, for each explained variable,
the visualization unit visualizes the plurality of kinds of predictive models to receive the selection of a predictive model from the user, for each explained variable and
the optimization unit calculates an objective variable optimizing an objective function under constraints, the objective function using a predictive model selected by the user for each explained variable as an argument.

3. The information processing system according to claim 1, wherein
the visualization unit uses test data including a value of an explained variable and a value of an explanatory variable in the past to calculate a value of an explained variable for each predictive model, and visualizes a difference between a value of the explained variable and a value of the explained variable in the past.

4. The information processing system according to claim 1, wherein
the visualization unit receives user's editing operation to a visualized predictive model.

5. The information processing system according to claim 1, wherein
the learning unit learns a predictive model upon receiving user's operation giving an instruction to perform learning of a predictive model.

6. An information processing method comprising:
learning a predictive model on the basis of an explained variable and explanatory variables, the predictive model representing a relationship between the explained variable and the explanatory variables and being expressed by a function of the explanatory variables;
visualizing the predictive model; and
calculating an objective variable to optimize an objective function using the visualized predictive model as an argument, under constraints, upon receiving user's operation.

7. A non-transitory computer-readable recording medium in which an information processing program is recorded, the information processing program causing a computer to execute:
a learning process of learning a predictive model on the basis of an explained variable and explanatory variables, the predictive model representing a relationship between the explained variable and the explanatory variables and being expressed by a function of the explanatory variables;
a visualization process of visualizing the predictive model; and
an optimization process of calculating an objective variable optimizing an objective function under constraints upon receiving user's operation, the objective function using as an argument the predictive model visualized in the visualization process.
